(19) United States
(12) Patent Application Publication
(10) Pub. No.: US 2012/0015242 A1
(43) Pub. Date: Jan. 19, 2012

(54) BATTERY WITH IMPROVED TERMINALS

(75) Inventors: Philippe Hart Gow, Santa Monica, CA (US); Broc William TenHouten, Santa Monica, CA (US)

(73) Assignee: Coda Automotive, Inc., Los Angeles, CA (US)

(21) Appl. No.: 13/160,646

(22) Filed: Jun. 15, 2011

Related U.S. Application Data
(60) Provisional application No. 61/364,977, filed on Jul. 16, 2010.

(51) Int. Cl. H01M 2/30; H01M 2/08; H01M 10/00; H01M 2/04

(52) U.S. Cl. 429/179

(57) ABSTRACT

A battery or battery cell may include a casing, a battery cell core housed within the casing and at least one terminal electrically connected to the cell core. The battery or cell may also include a lid or sealing plate to seal the cell core within the casing. The terminal may be mounted to the lid with a pair of fasteners, such as rivets, that are aligned along a longitudinal axis that is offset relative to the terminal so that a portion of the terminal on one side of the axis is larger than a portion of the terminal on the other side of the axis. Such an arrangement may provide a relatively large surface portion for connection to the terminal. The battery or cell may include a pair of terminals that are each mounted to the lid by a pair of fasteners. One terminal may be mounted with fasteners having a size and/or spacing that is different from the size and/or spacing of the fasteners mounting the other terminal. Such an arrangement may provide a keying-like feature for the terminals. A seal and/or insulator may be provided for sealing and/or electrically insulating each terminal.

### RELATED APPLICATIONS

This application claims priority under 35 U.S.C. §119(e) to U.S. Provisional Patent Application No. 61/364,977, filed Jul. 16, 2010, and entitled “Battery with Improved Terminals,” which is incorporated herein by reference in its entirety for all purposes.

### BACKGROUND

High capacity batteries or battery cells have been developed for various applications, including electric vehicles. Such batteries or cells may include a casing with a pair of terminals that serve to transmit electrical current through the cell casing. In this regard, the terminals are electrically and mechanically connected to electrodes housed within the casing, typically using current-conducting tabs that are attached to electrode current collectors.

Battery terminals may form a hermetic seal to prevent the loss of electrolyte or intrusion of moisture. For batteries or cells that employ a metallic casing, the terminals may also be electrically insulated from the casing.

External connections to a battery or cell are conventionally accomplished by connecting the terminals with busbars or other cell-to-cell interconnects. Such connections have conventionally been accomplished using bolts or screws that are threaded into the terminals or using nuts that are threaded onto terminal posts.

For a battery or cell with a fixed envelope or volume, screw-type terminals may reduce the amount of volume available for storage capacity. Other battery or cell connections may be accomplished by welding the cell interconnect to the terminal which may require less volume than a screw-type connection. It is also known to use riveted terminals. An example of a battery employing riveted terminals is disclosed in U.S. Patent Application Publication No. 2008/0213657.

### SUMMARY

In one illustrative embodiment, a battery cell comprises a casing, a cell core housed within the casing, a sealing lid that seals the cell core in the casing, a first terminal electrically connected to the cell core, and a second terminal electrically connected to the cell core. The first terminal is mounted to the sealing lid with a pair of first fasteners that are spaced apart a first distance, and the second terminal is mounted to the sealing lid with a pair of second fasteners that are spaced apart a second distance that is different from the first distance between the first fasteners.

In another illustrative embodiment, a battery cell comprises a casing, a cell core housed within the casing, a sealing lid that seals the cell core in the casing, a first terminal electrically connected to the cell core, and a second terminal electrically connected to the cell core. The first terminal is mounted to the sealing lid with a pair of first fasteners having a first diameter, and the second terminal is mounted to the sealing lid with a pair of second fasteners having a second diameter that is different from the first diameter of the first fasteners.

In another illustrative embodiment, a battery cell comprises a casing, a cell core housed within the casing, a sealing lid that seals the cell core in the casing, and at least one terminal electrically connected to the cell core. The at least one terminal is mounted to the sealing lid with a pair of fasteners that are aligned with each other along an axis that is offset from a center of the at least one terminal. The at least one terminal includes a first portion on a first side of the axis and a second portion on a second side of the axis that is larger than the first portion.

### BRIEF DESCRIPTION OF DRAWINGS

Various embodiments of the invention will now be described, by way of example, with reference to the accompanying drawings, in which:

FIG. 1 is a perspective view of a battery cell according to one illustrative embodiment of the present invention;

FIG. 2 is a cross-sectional view taken along section line 2-2 of FIG. 1 illustrating a battery terminal according to one illustrative embodiment of the invention;

FIG. 3 is a cross-sectional view similar to FIG. 2 illustrating another embodiment of a seal for the battery terminal;

FIG. 4 is a perspective view of the seal of FIG. 3 for the battery terminal;

FIG. 5 is a top view of the battery cell of FIG. 1;

FIG. 6 is a bottom view of the battery cell lid of FIG. 5; and

FIG. 7 is a schematic top view of the battery cell of FIGS. 1-6 connected to busbars according to one illustrative embodiment of the invention.

### DETAILED DESCRIPTION

The present invention is directed to a battery or battery cell, such as a high capacity battery or cell, that may be particularly suited for use with electric vehicles. However, the battery or cell may have other suitable applications and is not limited to use with electric vehicles.

The battery or cell may include a casing, a battery cell core housed within the casing and one or more terminals electrically connected to the battery cell core. The battery or cell may also include a lid or seal plate to seal the battery cell core within the casing.

The battery or cell may include a pair of terminals that are each mounted to the lid by a pair of fasteners. According to one embodiment, the fasteners may include rivets. However, it is to be understood that the use of rivets is not required for each embodiment of the invention.

According to one embodiment, one terminal may be mounted with fasteners having a size and/or spacing that is different from the size and/or spacing of the fasteners mounting the other terminal. Such an arrangement may provide a keying-arrangement for the terminals. However, it is to be understood that the use of fasteners with different sizes and/or spacing is not required for each embodiment of the invention.

According to one embodiment, each terminal may be mounted to the lid with a pair of fasteners, such as rivets, that are aligned along a longitudinal axis that is offset relative to the terminal so that a portion of the terminal on one side of the axis is larger than a portion of the terminal on the other side of the axis. Such an arrangement may provide a relatively large surface portion or area for connection to the terminal. However, it is to be understood that an offset terminal mounting arrangement is not required for each embodiment of the invention.

According to one embodiment, a seal and/or insulator may be provided on the lid for sealing and/or electrically insulating each terminal. In one aspect, a separate seal or insulator may be provided for each terminal. In another aspect, one seal may be utilized for multiple terminals. In one embodiment, each seal/insulator may be over-molded onto the lid. However, it is to be understood that an over-molded seal or insulator is not required for each embodiment of the invention.

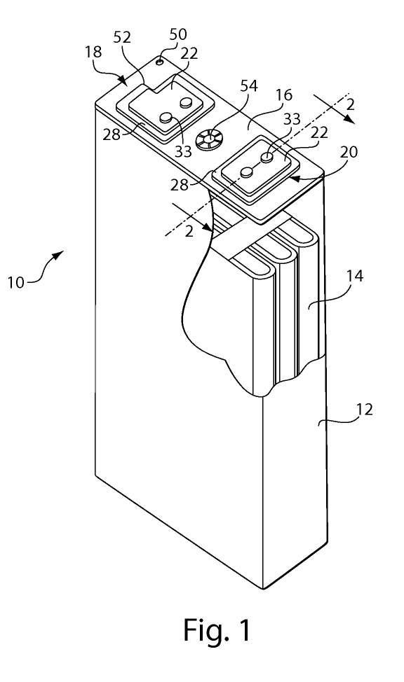

In one illustrative embodiment shown in FIG. 1, the battery or battery cell 10 may include a cell casing or housing 12, a battery or cell core 14 housed within the cell casing, and a sealing lid or cover 16 that seals the cell casing. A pair of terminals 18, 20, such as positive and negative terminals, may be supported on the lid for electrically connecting the internal battery or cell core to one or more external interconnects. However, it is to be appreciated that one or more terminals may be provided on the battery or cell lid.

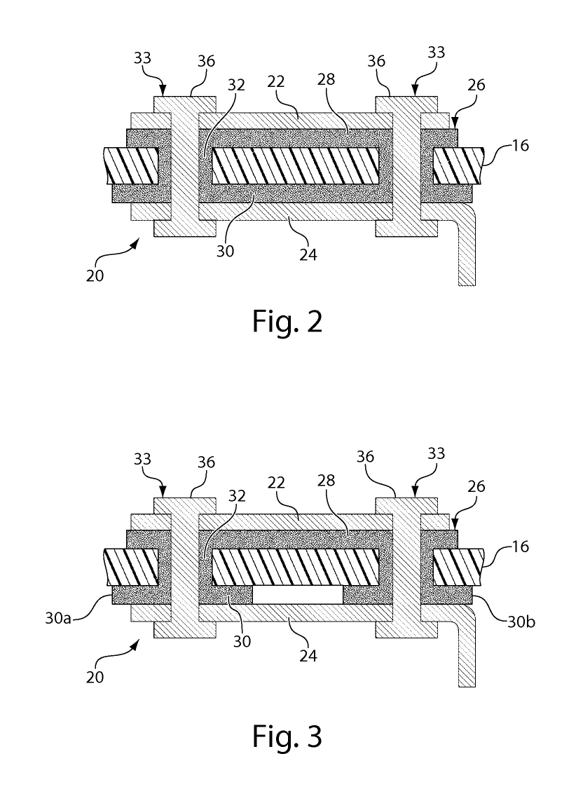

In one illustrative embodiment shown in FIG. 2, each terminal 18, 20 may include a first or external terminal tab 22 and a second or internal terminal tab 24 that are located on opposite sides of the lid 16. One or more fasteners may pass through corresponding holes in the lid 16 and the terminal tabs 22, 24 to join the terminal tabs to each other.

One or more seals may be provided to seal the terminals against leakage of electrolyte from the casing. In one embodiment, a separate seal may be provided for each terminal. In another embodiment, one seal may be provided for multiple terminals.

In one illustrative embodiment shown in FIG. 2, the seal 26 may include an external seal 28 and an internal seal 30 that are located between the lid 16 and the external terminal tab 22 and the internal terminal tab 24, respectively. One of the external and internal seals may include a boss or protuberance 32 that is configured to extend or project through and seal the fastener hole provided in the lid 16.

The seal 26 may be formed as a single unitary component, such as a grommet, with the external seal 28, the internal seal 30 and the boss 32 being integrated as a single piece. Alternatively, the seal may be formed with separate components that together provide the desired sealing function. If desired, each seal may be bonded or heat sealed to the lid. However, it is to be understood that bonding or heat sealing the seal to the lid is not required for each embodiment of the invention.

In one embodiment, the external and internal seals 28, 30 are formed as separate components with the boss 32 included as an integral part of either the external seal or the internal seal. Such an arrangement may help ease installation and allow the use of seal components having different sizes and/or configurations suitable for a particular application.

In one illustrative embodiment shown in FIG. 2, the external seal 28, the internal seal 30 and the boss 32 may be may be integrated together on the lid 16 to form a single unitary seal structure. The external and internal seals may be formed as separate components that are joined together on the lid to form a unitary seal structure. In one embodiment, the external and internal seals may be heat-fused together to form the integrated seal. However, it is to be understood that the seals may be joined to form the integrated seal using any suitable technique as would be apparent to one of ordinary skill in the art.

In one embodiment, each seal may include a preformed grommet-like seal that is installed on the lid by feeding either the internal or external seal through a corresponding hole in the lid in a manner as would be apparent to one of skill in the art.

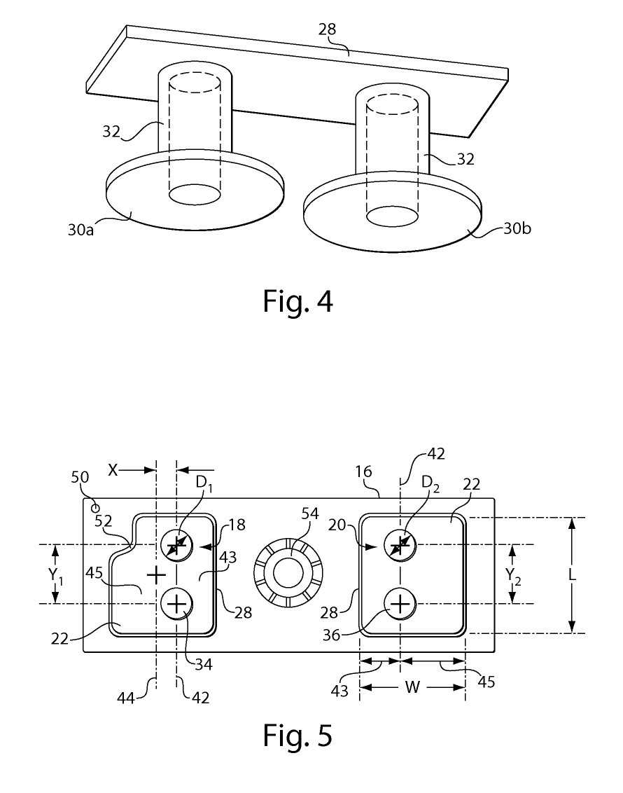

Each seal may include one or more holes and may be configured to seal one or more terminals. In one illustrative embodiment shown in FIGS. 3-4, the external seal 28 may be formed as a single seal portion with multiple holes for receiving multiple terminal fasteners, and the internal seal 30 may be formed as individual seal portions 30a, 30b that are integrally formed with and extend from the single external seal 28 at each of the fastener holes. Each individual seal portion 30a, 30b may be configured to be installed through a corresponding hole in the lid with the external seal 28 extending across the outer surface of the lid. If desired, the internal seal may be formed as a single seal portion with the external seals being integrally formed as individual seal portions extending from the single internal seal.

For some applications, it may be desirable to seal each seal 26 to the lid 16. In one embodiment, each seal may be adhesively bonded to the lid. In another embodiment, each seal may be heat fused to the lid. However, it is to be appreciated that each seal may be sealed to the lid using any suitable technique as would be apparent to one of skill in the art.

In one embodiment, the integrated seal may be formed by over-molding the external seal 28, the internal seal 30 and the boss 32 onto the lid as a single structure. Over-molding the seal 26 in this manner may ease assembly of the battery or cell because the seal is pre-assembled on the lid. The over-molded seal may also be desirable because it may allow the external and internal seals 28, 30 to be formed with various shapes and configurations suitable for particular applications that may otherwise be difficult to implement or attain with a preformed grommet-like seal that would need to be installed on the lid.

In one embodiment, the over-molded seal 26 may be injection molded onto the lid 16 in a manner apparent to one of skill in the art. However, it is to be understood that the seal may be over-molded on the lid using any suitable molding techniques as would be apparent to one of skill in the art.

The seal 26 may also act as an insulator to electrically insulate the terminal tabs 22, 24 from the lid. In this regard, the seal 26 may be formed of a material that provides both sealing and electrical insulation properties. In one embodiment, the insulating seal may be formed of a chemically inert, high temperature fluoro-polymer material. However, it is to be understood that the seal may be formed of any suitable material apparent to one of skill in the art to provide any one or a combination of desirable properties, including sealing, electrical insulation and/or chemical resistant properties.

In one embodiment, each terminal 18, 20 is joined to the lid 16 using a pair of fasteners 33 to help reduce or avoid potential rotation of the external and internal terminal tabs that could potentially lead to a short circuit or failure of a terminal seal. It is to be understood, however, that a pair of fasteners is not required for each embodiment of the battery or cell and that a single fastener may be employed to join each terminal to the sealing lid.

In one embodiment, the terminals 18, 20 are mounted with a pair of rivets. Such an arrangement may help reduce the amount of overall battery or cell volume that is occupied by the fasteners so that a greater amount of the overall battery or cell volume is available for storage capacity. The rivets may also enhance the sealing capability of the terminal seals due to the diametrical swelling action of the rivets combined with the rivet-induced compression of the external and internal seals 28, 30 between the sealing lid and the external and internal terminal tabs 22, 24. The rivets may also include relatively large flat heads to create a compression seal on the seals. Although the use of rivets may provide one or more advantages, it is to be appreciated that any suitable fastener may be employed to mount the terminals to the sealing lid as would be apparent to one of skill in the art.

To facilitate assembly of the terminals, it may be desirable to pre-join the fasteners to one of the external or internal terminal tabs 22, 24. For example, rivets may be pre-joined to a terminal tab via press-fit, coining or welding. However, any suitable technique may be utilized to pre-join fasteners to the terminal tabs, if desired, as would be apparent to one of skill.

For some applications, it may be desirable to configure the terminal fasteners 33 with one or more features to connect the terminals to cell interconnects after battery or cell assembly. In one embodiment, each fastener may be a rivet that includes an external extension configured to be riveted to a cell interconnect. Such a fastener configuration may be installed from the external terminal tab side of the terminals.

It may be desirable to provide one or more keying features that may facilitate assembling and/or interconnecting the terminals. As one example, it may be desirable to reduce the possibility of inadvertently switching the anode and/or cathode internal tab attachment to the terminals. As another example, it may be desirable to facilitate proper orientation of the battery or cell relative to external connections, such as busbars.

In one embodiment, one of the terminals may be mounted with fasteners having a size and/or spacing that is different from the size and/or spacing of the fasteners mounting the other terminal. Such arrangements may ensure that terminal components designed particularly for use as a cathode or anode are properly assembled to the sealing lid.

In one illustrative embodiment shown in FIG. 5, the first terminal 18 may be mounted with a pair of first fasteners 34 that are spaced apart a first distance Y₁ and the second terminal 20 may be mounted with a pair of second fasteners 36 that are spaced apart by a second distance Y₂ that is less than the first distance. In one embodiment, the first distance Y₁ between the first fasteners 34 may be approximately 14 mm and the second distance Y₂ between the second fasteners 36 may be approximately 10 mm. It is to be understood that any suitable spacing between the fasteners may be employed to mount the terminals to the sealing lid.

In one illustrative embodiment shown in FIG. 7, the terminals may be configured to connect with external busbars 38, 40 for interconnecting the terminal of the battery or cell. As shown, one busbar 38 may include a projection 41 that is configured to fit only between the fasteners 34 of the first terminal 18 to ensure that the battery or cell is interconnected to the proper busbar. It is to be understood, however, that the terminals may be configured to interconnect in any suitable manner as would be apparent to one of skill in the art.

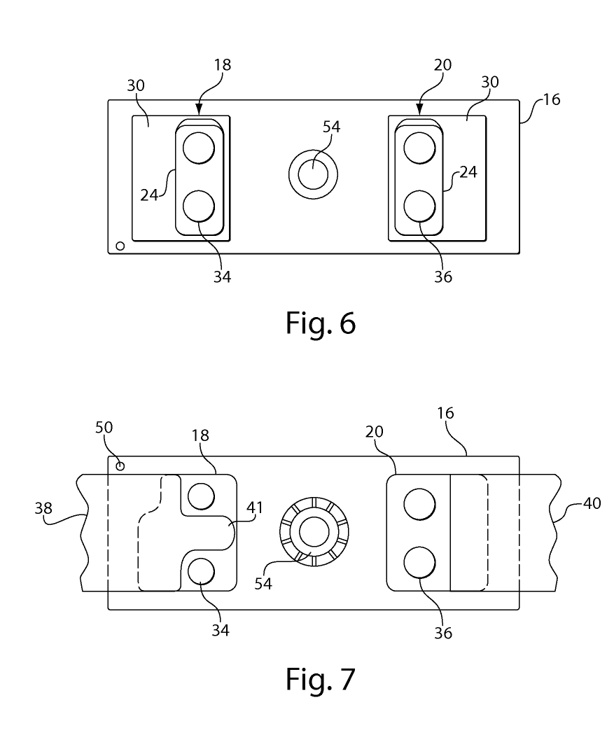

In one embodiment shown in FIGS. 5-6, the first terminal 18 may be mounted with a pair of first fasteners 34 having a first diameter D₁ and the second terminal 20 may be mounted with a pair of second fasteners 36 having a second diameter D₂ that is larger than the diameter of the first fasteners. In one embodiment, the first fasteners 34 may have a first diameter D₁ of approximately 4.5 mm and the second fasteners 36 may have a second diameter D₂ of approximately 6.0 mm.

Such an arrangement may help ensure that the proper fasteners are employed to mount the terminals to the sealing lid. For example, the first and second terminals 18, 20 may be mounted with fasteners 34, 36 having different diameters corresponding to a particular material for use as a cathode or anode. In one embodiment, the first fasteners 34 may be made from copper and the second fasteners 36 may be made from aluminum.

Although the terminals 18, 20 in the illustrative embodiment may be mounted with fasteners 34, 36 having different spacing, different sizes and different materials, it is to be understood that the terminals may be mounted with fasteners having the same or different spacing, the same or different sizes and/or the same or other suitable materials as would be apparent to one of skill in the art. It is also to be appreciated that other keying features, if desired, may be employed with the terminals as would be apparent to one of skill in the art.

It may be desirable to configure and/or mount one or more of the terminals 18, 20 in a manner that provides a relatively large surface or contact area for interconnecting the terminals. In one illustrative embodiment shown in FIG. 5, each terminal 18, 20 may be mounted to the sealing lid 16 with a pair of fasteners 34, 36 that are aligned along a longitudinal axis 42 that is offset from the center 44 of the terminal. Such an arrangement provides a first portion 43 of the terminal on one side of the axis and a second portion 45 of the terminal on the other side of the axis that is larger than the first portion. In this manner, the second portion of the terminal has a relatively large uninterrupted surface or contact surface available for connecting to the battery or battery cell.

In one illustrative embodiment shown in FIG. 5, each external terminal has a length L of approximately 21 mm and a width W of approximately 16 mm. Each terminal is mounted with a pair of fasteners that are offset from the center of the external terminal by a distance X of approximately 2 mm. However, it is to be appreciated that the terminals may be configured with any suitable shape and size and to be mounted with any suitable offset as would be apparent to one of skill in the art.

As shown in FIGS. 1 and 5-6, each terminal tab 22, 24 may include a plate having generally rectangular or square configurations. It is to be appreciated, however, that the terminal tabs may be configured to have any suitable shape for providing a desired connection as would be apparent to one of skill.

It may be desirable to form the fasteners and internal terminal components of materials that are stable at the respective anode and cathode potentials. In one embodiment, the internal terminal tabs, the fasteners and the current collectors are made of the same base material to prevent corrosion that may otherwise occur due to wet connections with dissimilar materials. In one embodiment, the terminal components may be formed of nickel-plated copper, although any suitable materials may be utilized as would be apparent to one of skill.

It may be desirable to form the external components of the terminals of material capable of being joined to various interconnects, for example, welded external terminals. In one embodiment, the external terminal tabs may be formed of nickel or nickel-plated steel to facilitate welding of a cell interconnect to the terminals. However, any suitable materials may be utilized as would be apparent to one of skill.

The battery or cell 10 may include a port or opening that is used for filling the casing 12 with electrolyte. As shown in FIG. 1, the port 50 may be located in a corner of the lid 16. The external terminal tab 22 of the first terminal 18 may include a cutout or relief 52 to accommodate the port. However, the port, if provided, may be provided at any suitable location as would be apparent to one of skill in the art. After electrolyte is injected through the port and into the casing, the port may be sealed using any suitable technique as would apparent to one of skill in the art.

It may be desirable to provide one or more safety features for reducing a potential battery or cell explosion. In one illustrative embodiment, a pressure limiting rupture disk 54 may be provided in the lid 16. As shown, the pressure limiting rupture disk may be located between the terminals 18, 20. However, it is to be understood that a pressure limiting rupture disk, if desired, may be provided in any suitable location as would be apparent to one of skill.

U.S. Provisional Patent Application No. 61/364,977, filed Jul. 16, 2010, and entitled “Battery with Improved Terminals” is incorporated herein by reference in its entirety for all purposes.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. A battery cell comprising:
a casing;
a cell core housed within the casing;
a sealing lid that seals the cell core in the casing;
a first terminal electrically connected to the cell core, the first terminal being mounted to the sealing lid with a pair of first fasteners that are spaced apart a first distance; and
a second terminal electrically connected to the cell core, the second terminal being mounted to the sealing lid with a pair of second fasteners that are spaced apart a second distance that is different from the first distance between the first fasteners.

2. The battery cell according to claim 1, further comprising a first seal adapted to seal the first terminal against leakage from the casing and a second seal adapted to seal the second terminal against leakage from the casing.

3. The battery cell according to claim 2, wherein each of the first and second terminals includes an external terminal tab and an internal terminal tab located on opposite sides of the sealing lid, and wherein each seal includes an external seal located between the external terminal tab and the sealing lid and an internal seal located between the internal terminal tab and the sealing lid.

4. The battery cell according to claim 1, wherein the pair of first fasteners is aligned with each other along an axis that is offset from a center of the first terminal, the first terminal including a first portion on a first side of the axis and a second portion on a second side of the axis that is larger than the first portion.

5. The battery cell according to claim 4, wherein the pair of second fasteners is aligned with each other along an axis that is offset from a center of the second terminal, the second terminal including a first portion on a first side of the axis and a second portion on a second side of the axis that is larger than the first portion.

6. The battery cell according to claim 1, wherein each of the first fasteners has a first diameter and each of the second fasteners has a second diameter that is different from the first diameter of the first fasteners.

7. A battery cell comprising:
a casing;
a cell core housed within the casing;
a sealing lid that seals the cell core in the casing;
a first terminal electrically connected to the cell core, the first terminal being mounted to the sealing lid with a pair of first fasteners having a first diameter; and
a second terminal electrically connected to the cell core, the second terminal being mounted to the sealing lid with a pair of second fasteners having a second diameter that is different from the first diameter of the first fasteners.

8. The battery cell according to claim 7, further comprising a first seal adapted to seal the first terminal against leakage from the casing and a second seal adapted to seal the second terminal against leakage from the casing.

9. The battery cell according to claim 8, wherein each of the first and second terminals includes an external terminal tab and an internal terminal tab located on opposite sides of the sealing lid, and wherein each seal includes an external seal located between the external terminal tab and the sealing lid, an internal seal located between the internal terminal tab and the sealing lid and a sealing boss extending through the sealing lid from the external seal to the internal seal.

10. The battery cell according to claim 7, wherein the pair of first fasteners is aligned with each other along an axis that is offset from a center of the first terminal, the first terminal including a first portion on a first side of the axis and a second portion on a second side of the axis that is larger than the first portion.

11. The battery cell according to claim 10, wherein the pair of second fasteners is aligned with each other along an axis that is offset from a center of the second terminal, the second terminal including a first portion on a first side of the axis and a second portion on a second side of the axis that is larger than the first portion.

12. The battery cell according to claim 7, wherein the pair of first fasteners are spaced apart a first distance and the pair of second fasteners are spaced apart a second distance that is different from the first distance between the first fasteners.

13. A battery cell comprising:
a casing;
a cell core housed within the casing;
a sealing lid that seals the cell core in the casing; and
at least one terminal electrically connected to the cell core, the at least one terminal being mounted to the sealing lid with a pair of fasteners, the fasteners being aligned with each other along an axis that is offset from a center of the at least one terminal, the at least one terminal including a first portion on a first side of the axis and a second portion on a second side of the axis that is larger than the first portion.

14. The battery cell according to claim 13, further comprising at least one seal adapted to seal the at least one terminal against leakage from the casing.

15. The battery cell according to claim 14, wherein the at least one terminal includes an external terminal tab and an internal terminal tab located on opposite sides of the sealing lid, and wherein the at least one seal includes an external seal located between the external terminal tab and the sealing lid, an internal seal located between the internal terminal tab and the sealing lid and a sealing boss extending through the sealing lid from the external seal to the internal seal.

16. The battery cell according to claim 14, wherein the at least one terminal includes a first terminal and a second terminal and wherein the at least one seal includes a first seal and a second seal that are over-molded onto the sealing lid, the first seal adapted to seal the first terminal and the second seal adapted to seal the second terminal.

17. The battery cell according to claim 16, wherein each of the first and second terminals is mounted to the sealing lid with a pair of fasteners.

18. The battery cell according to claim 17, wherein the first terminal is mounted to the sealing lid with a pair of first fasteners that are spaced apart a first distance, and the second terminal is mounted to the sealing lid with a pair of second fasteners that are spaced apart a second distance that is different from the first distance between the first fasteners.

19. The battery cell according to claim 18, wherein each of the pair of first fasteners has a first diameter, and each of the pair of second fasteners has a second diameter that is different from the first diameter of the first fasteners.

20. The battery cell according to claim 17, wherein each fastener includes a rivet that is adapted to compress a corresponding seal between a corresponding terminal and the sealing lid.
